(19) United States
(12) Patent Application Publication
(10) Pub. No.: US 2015/0306970 A1
(43) Pub. Date: Oct. 29, 2015

(54) ENERGY MANAGEMENT METHOD AND ENERGY MANAGEMENT SYSTEM USING SAME

(71) Applicant: ELECTRONICS AND TELECOMMUNICATIONS RESEARCH INSTITUTE, Daejeon (KR)

(72) Inventor: Myunghee SON, Daejeon (KR)

(73) Assignee: Electronics and Telecommunications Research Institute, Daejeon (KR)

(21) Appl. No.: 14/436,958

(22) PCT Filed: Jul. 7, 2013
(86) PCT No.: PCT/KR2013/006373

§ 371 Date: Apr. 20, 2015

(30) Foreign Application Priority Data
Jul. 18, 2012 (KR) 10-2012-0078156
May 30, 2013 (KR) 10-2013-0061421

(51) Int. Cl. B60L 11/18; B60L 3/12

(52) U.S. Cl. CPC B60L 11/1861; B60L 11/1838; B60L 3/12

(57) ABSTRACT

An energy management method and an energy management system are disclosed. The energy management method, according to one aspect of the present invention, comprises the steps of: collecting electric vehicle energy-related information from one or more electric vehicles; collecting power generation-related information from one or more new renewable energy power plants; and comparing the total amount of the collected power and a predicted amount of electric vehicle consumption to process a surplus energy or power amount.

### TECHNICAL FIELD

The present invention relates to energy management for an electric vehicle, and more particularly, to a method for managing new renewable energy and an energy managing system for an electric vehicle.

### BACKGROUND ART

New renewable energy and green industries using such new renewable energy are garnering attention because of problems of global warming and exhaustion of resources. Specifically, studies on electric vehicles (EVs) have been conducted more actively recently due to problems of exhaustion of oil energy and air pollution.

A charging method of an EV may be classified as a stop method or a non-stop method or may be classified as a contact method or a non-contact method according to classification method. The stop method charge is a charge method in which a battery of a car is charged with electricity or a fuel cell is changed by using charging equipment after the car stops such is in an EV driven by a battery or an EV driven by a fuel cell, and the non-stop method charge is a charge method in which a car is charged while driving without stopping.

Meanwhile, the contact method charge is a method for charging quickly through a charge line between the car and the charging equipment by connecting a plug-in cord, and the non-contact method is a method for charging in non-contact method without a direct connection line between the car and the charge equipment.

In relation with this, currently in Korea, a DC current generated from sunlight is converted to an AC current through an inverter and transferred to KEPCO's power network. In addition, in the case of an EV, the AC transferred to a home or a specific charging station from the power network through transmission and distribution processes is converted to DC and is charged to the EV.

Conventionally, power leakage is great because leakage due to conversion and leakage due to transmission and distribution are added when the DC current generated from the sunlight is transmitted to the power network. Specifically, because unit cost of generation is markedly high in the case of new renewable energy, a method for storing energy in a battery while minimizing power conversion is required.

New renewable energy includes energy using exiting fossil fuels by converting the fossil fuels or using renewable energy including sunlight, water, geothermal heat, rainfall, organisms and so on by converting the renewable energy, and new renewable energy generation refers to producing electricity using such types of new renewable energy. Future energy sources for continuous energy supply systems are characterized by new renewable energy generation, and the importance of new renewable energy is increasing due to the instability of oil prices, restrictions in climate change agreements and so on.

However, power instability of new renewable energy can reach 90%, and thus a load is placed on a grid network when surplus power generated in a moment is directly transmitted to an energy grid.

### DISCLOSURE

### Technical Problem

The present invention is directed to providing a management method by which surplus power generated in a moment can be stored using an electric vehicle (EV).

The present invention is also directed to providing an energy managing system using the above-mentioned method.

The present invention is also directed to providing an EV performing charging using the above-mentioned method.

### Technical Solution

One aspect of the present invention provides a method for managing energy including: collecting electric vehicle (EV) energy related information from at least one EV, gathering generation related information from at least one new renewable energy plant, and processing a surplus power amount or generation amount by comparing a gathered overall generation amount with an anticipated EV consumption amount.

The processing of the surplus power amount or generation amount may include transmitting the surplus power amount to an energy grid when the overall generation amount is greater than the anticipated EV consumption amount.

The processing of the surplus power amount or generation amount may include storing the generation amount in a charging station or the EV when the overall generation amount is equal to or less than the anticipated EV consumption amount.

The EV energy related information may include information about a driving location and remaining battery capacity of the EV.

The generation related information may include information about at least one of a charging station location, generation efficiency and an anticipation generation amount.

The method may further include detecting the EV that needs to be charged from the collected EV energy related information, selecting a charging station for the EV that needs to be charged, and transmitting information about the selected charging station to the EV that needs to be charged.

In the method for managing energy, the processing of the surplus power amount or generation amount may further include charging the EV according to a flexible fee priced according to at least one charge standard when the generation amount is stored in the EV.

The charge standard may include at least one of a power consumption rate of the EV, a moving distance from the EV to a charging station, and remaining battery capacity of the EV.

Another aspect of the present invention provides an energy managing system including: an energy information collection part configured to collect EV energy related information from at least one EV, a generation information collection part configured to gather generation related information from at least one new renewable energy plant, and a control part configured to process a surplus power amount or generation amount by comparing a gathered overall generation amount with an anticipated EV consumption amount.

The control part may transmit the surplus power amount to an energy grid when the overall generation amount is greater than the anticipated EV consumption amount.

The control part may control a charging station or the EV to store the generation amount in the charging station or the EV when the overall generation amount is equal to or less than the anticipated EV consumption amount.

The control part may detect the EV that needs to be charged from the EV energy related information collected by the energy information collection part, select a charging station for the EV that needs to be charged, and transmit information about the selected charging station to the EV that needs to be charged.

The EV energy related information may include information about a driving location and remaining battery capacity of the EV.

The generation related information may include information about at least one of a charging station location, generation efficiency and an anticipation generation amount.

The control part may charge the EV according to a flexible fee priced according to at least one charge standard when the generation amount is stored in the EV.

The charge standard may include at least one of power a consumption rate of the EV, a moving distance from the EV to a charging station, and remaining battery capacity of the EV.

The energy managing system may further include a database configured to store the EV energy related information and generation related information collected by the energy information collection part and the generation information collection part.

Still another aspect of the present invention provides an EV including: an energy information transmission part configured to periodically transmit EV energy related information to a data center and a charge control part configured to determine whether charging is needed based on remaining battery capacity information, transmit a charge guide request to the data center when the charging is needed, and receive a charging station guide message from the data center.

The EV energy related information may include information about a driving location and remaining battery capacity of the EV.

### Advantageous Effects

According to the present invention as described above, electricity generated in new renewable energy is directly charged to an electric vehicle (EV) through a data exchange between the EV and a data center, and thus charge unit price of the EV may be effectively decreased through non-conversion of the new renewable energy.

In addition, according to the present invention, surplus power generated in a moment may be dispersed and stored to the EV.

### DESCRIPTION OF DRAWINGS

FIG. 1 is a conceptual diagram illustrating a charging system for an electric vehicle (EV) according to the present invention.

FIG. 2 is a flow chart illustration of an operation of the EV according to one example embodiment of the present invention.

FIG. 3 is a flow chart illustrating an operation for managing energy of a data center according to one example of the present invention.

FIG. 4 is an arrangement conceptual diagram illustrating the EV and a sunlight charging station used by the EV according to the present invention.

FIG. 5 is a conceptual diagram illustrating energy managed for selection of a charging station according to one example embodiment of the present invention.

FIG. 6 is a flow chart illustrating a method for applying a flexible fee according to one example embodiment of the present invention.

FIG. 7 is a block diagram illustrating the data center according to one example embodiment of the present invention.

### MODES OF THE INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail.

It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined here.

As used herein, the term “terminal” may be referred to as a mobile station (MS), user equipment (UE), user terminal (UT), wireless terminal, access terminal (AT), subscriber unit, subscriber station (SS), wireless device, wireless communication device, wireless transmit/receive unit (WTRU), moving node, mobile, or other terms. Various exemplary embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or terminals having a combination of such functions, but are not limited to these.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

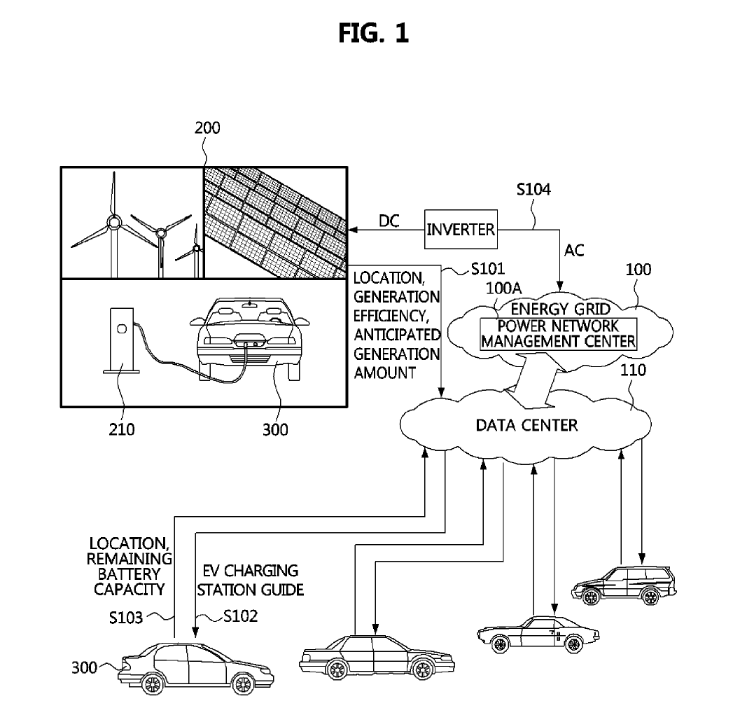

FIG. 1 is a conceptual diagram illustrating a charging system for an electric vehicle (EV) according to the present invention.

A structure of the charging system according to a preferable example embodiment for efficiently managing a balance between consumed power of the EV and power generated from new renewable energy is shown in FIG. 1.

Referring to FIG. 1, the charging system according to the present invention may include an energy grid 100, a data center 110, an energy generation complex 200 and a charging station 210.

The energy grid 100 includes the meaning of a smart grid, which refers to an intelligent power network. An energy grid or smart grid refers to a power network in which real time information is exchanged between a power provider and a customer to optimize energy efficiency by combining IT technology with a power network connected from generation to commercial transmission and distribution.

The energy grid 100 may include a power network management center 100A managing power related information as shown in FIG. 1, and the power network management center 100A is closely linked with the data center 110 performing energy management according to the present invention.

The EV 300 according to the present invention accesses the charging system as shown in FIG. 1, and receives power that will be consumed by the EV 300 from new renewable energy generation to increase energy efficiency.

In the energy generation complex 200 according to the present invention, new renewable energy generation is performed, for example, DC current generated from sunlight is converted to AC through an inverter and transmitted to the energy grid 100. The energy generation complex 200 produces at least one kind of energy among various kinds of new renewable energy including sunlight, solar heat, wind power, a fuel cell, hydrogen, bio, waste, coal gasification and liquefaction, geothermal heat, wind power, the ocean, etc.

The energy generation complex 200 according to the present invention transfers information about an installment location, generation efficiency, and an anticipated generation amount of the energy generation complex to the data center 110 S103.

The data center 110 according to the present invention receives the information about the installment location, the generation efficiency, and the anticipated generation amount of the energy generation complex from a plurality of energy generation complexes 200 established at several places, and detects a generation amount of a specific kind of new renewable energy. The data center 110 detecting the generation amount generated from each of the generation complexes guides the EV 300 that needs to be charged to the charging station 210 so that the EV 300 may be charged.

Each of the EVs 300 transfers information about its own driving location and remaining battery capacity to the data center 110 S103. The EV according to the present invention may include an energy information transmission part periodically transmitting EV energy related information to a data center, and a charging control part determining whether charging is needed based on remaining battery capacity information, transmitting a charging guide request to the data center and receiving a charging station guide message from the data center.

Meanwhile, when a surplus of electricity generated through new renewable energy generation at the energy generation complex 200 is generated, the surplus is applied to a system of the energy grid 100 S104. The data center 110 closely linked with the energy grid 100 constantly detects and manages an energy amount contained in the energy grid 100.

Thus, for example, when the EV 300 that needs to be charged should be charged with normal electricity because a new renewable energy generation amount is insufficient, the data center 110 may guide the EV 300 to a normal EV charging station by communicating with the power network management center 100A of the energy grid 100 S102.

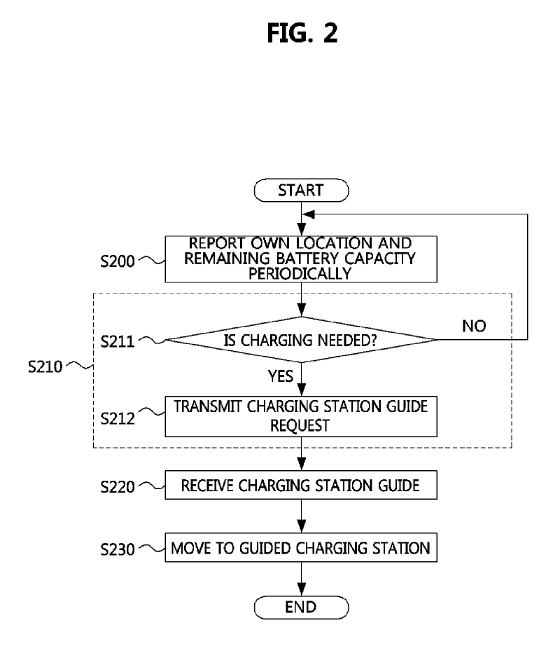

FIG. 2 is a flow chart illustration of an operation of the EV according to one example embodiment of the present invention.

The EV according to the present invention periodically transmits its own information, for example, information about a driving location and remaining battery capacity, to the data center (S200). In addition, the EV determines whether charging is needed based on the information about its own remaining battery capacity (S211), and transmits a charging station guide request to the data center when charging is needed (S212).

Meanwhile, the data center according to the present invention may determine that charging is needed when the remaining battery capacity of the EV is not greater than a critical value based on the received EV information and may guide the EV to a location of the best charging station. Thus, in this case, the procedure in which the EV determines that charging is needed and transmits the charging station guide request to the data center (S210) may be omitted.

That is, the charging station guide request (S210) may be a supplementary procedure in which the EV actively requests the guide to the data center when the EV needs to be recharged but cannot receive the proper charging station location guide.

When the EV receives the charging station guide from the data center (S220), the EV moves to the charging station to which it has been guided to perform the charging (S230).

The operation method of the EV shown in FIG. 2 may be realized as computer readable program codes in a computer readable recoding medium. The computer readable recording medium includes all kinds of recording devices in which data that is readable by a computer system is stored. Examples of the computer readable recording medium include a ROM, a RAM, a CD-ROM, a DVD-ROM, a Blu-ray disc, a magnetic tape, a floppy disk, an optic data storing device and so on, as well as carrier waves (for example, transmission through the Internet).

The computer readable recording medium on which the operation method according to the present invention is recorded may be attached to the EV or installed in a loadable terminal, and may be installed inside the EV. Here, the terminal may be any type of terminal.

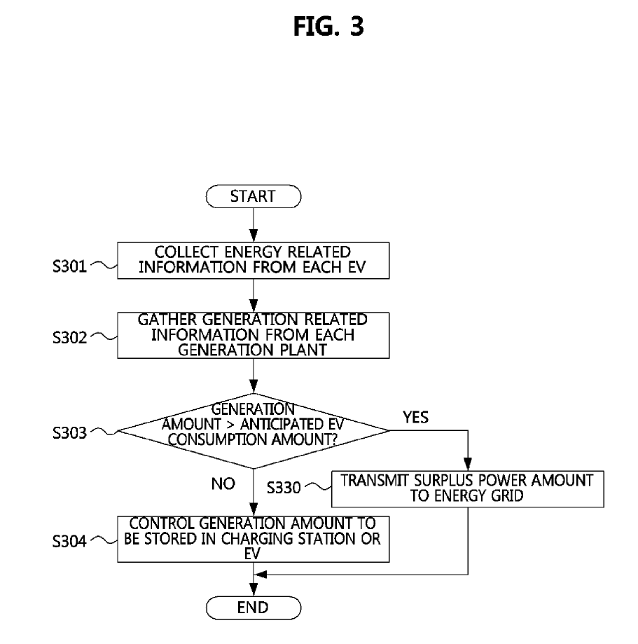

FIG. 3 is a flow chart illustrating an operation for managing energy of the data center according to one example of the present invention.

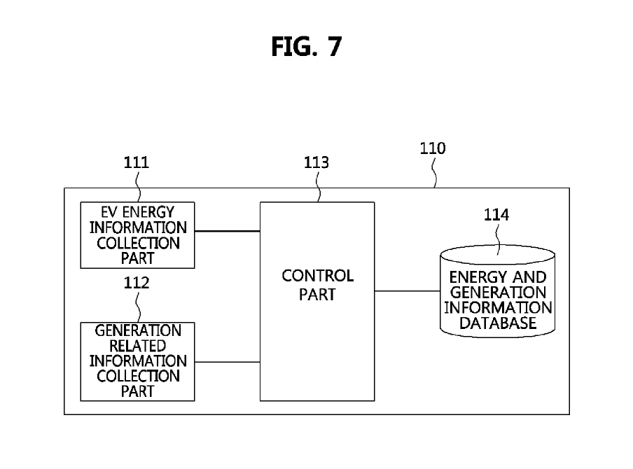

In description of the example embodiment below, each step of the method for managing energy of the present invention may be understood as an operation performed in a corresponding element in the data center described with reference to FIG. 7, however the individual steps of the method should only be limited by their own functions by which they are defined. That is, main agents performing the steps are not limited by the names of elements illustrated as performing the steps in the examples.

In description of the example embodiment shown in FIG. 2, the EV periodically transmits its own energy related information, for example, a driving location and remaining battery capacity, to the data center.

Thus, the data center collects the energy related information from the EV (S301), and manages information on the remaining battery capacity, location, and car speed calculated from the location information and so on for the EV.

In addition, each of the new renewable energy generation complexes according to the present invention transmits a charging location, generation efficiency and an anticipated generation amount to the data center. The data center according to the present invention gathers information from several new renewable energy generation plants (S302), and manages a generation amount for each new renewable energy generation plant.

Here, the step of collecting the energy related information from the EV (S301) and the step of gathering the information from the several new renewable energy generation plants (S302) are shown in sequence for convenience of description, but the steps are actually performed periodically and thus may be performed simultaneously or in reverse.

The energy center collecting the EV energy related information and generation related information determines whether the generation amount gathered from the new renewable energy generation plant is greater than an anticipated EV consumption amount (S303). When the generation amount is greater than the anticipated EV consumption amount, the surplus power amount is transmitted to the energy grid (S330). When the generation amount is not greater than the anticipated EV consumption amount, the generation amount is stored in a battery of the charging station or EV (S304).

Although not shown in FIG. 3, the data center guides the EV having charging priority to a proper charging station based on information about remaining battery capacity, location and car speed of each of the EVs so that the generation amount is effectively stored in the EVs.

Specifically, the method for managing energy according to the present invention may further include finding the EV that needs to be charged from the EV energy related information collected in step S301, selecting the charging station for the EV that needs to be charged, and transmitting the selected charging station related information to the EV.

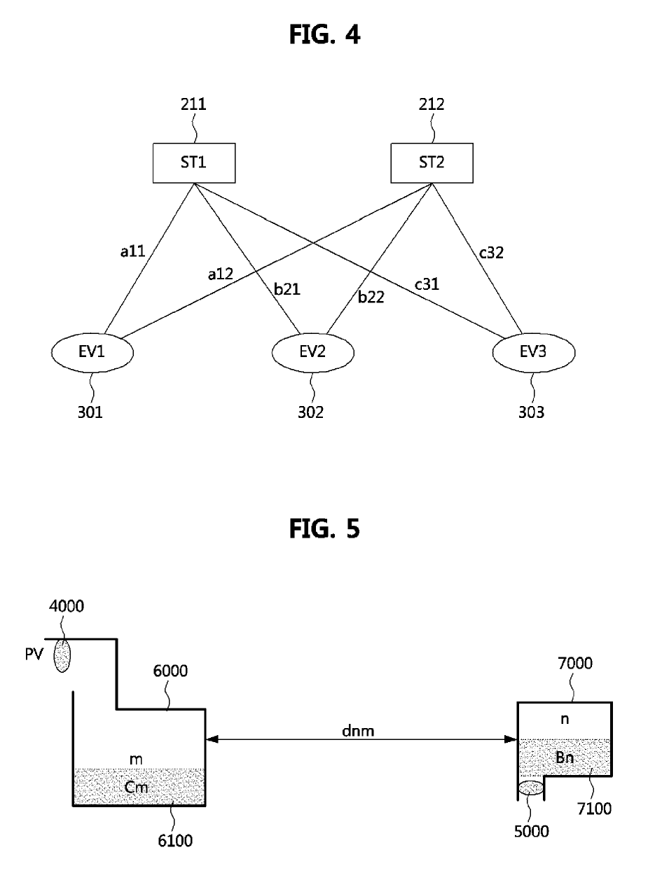

FIG. 4 is an arrangement conceptual diagram illustrating the EV and a solar charging station used by the EV according to the present invention.

In FIG. 4, it is assumed that there are two solar charging stations ST1 211 and ST2 212 and three EVs EV1 301, EV2 302 and EV3 303 located on a road.

In FIG. 4, all denotes a distance between the ST1 211 and the EV1 301, and a12 denotes a distance between the ST2 212 and the EV1 301. In addition, b21 denotes a distance between ST1 211 and the EV2 302, and b22 denotes a distance between the ST2 212 and the EV2 302. In addition, c31 denotes a distance between the ST1 211 and the EV3 303, and c32 denotes a distance between the ST2 212 and the EV3 303.

The data center according to the present invention continuously and periodically manages information about locations of each solar charging station, present locations of moving EVs and a moving distance from each solar charging station to the moving EV. In addition, the data center may perform effective energy provision and consumption by managing generation efficiency of each of the generation plants and power consumption rates of the EVs.

FIG. 5 is a conceptual diagram illustrating energy managed for selection of the charging station according to one example embodiment of the present invention.

In FIG. 5, an example embodiment when the charging station is the solar charging station is described. In FIG. 5, dmn denotes a distance between the charging station m and the EV n, Cm means generation efficiency of the charging station m, and for example, the generation efficiency of the charging station is related to a present generation amount, an amount presently stored in a battery, an anticipated generation amount etc. In addition, Bn means a power consumption rate of the EV n, and for example, the power consumption rate of the EV is related to present car speed, present power consumption, present remaining battery capacity, etc.

Referring to FIG. 5, information about a battery storage capacity 6000 of a solar charging station 210 in which energy provided from sunlight is limited, an energy amount 4000 generated per unit time from photovoltaic (PV) and a present charged amount 610 is conceptually shown in FIG. 5. In addition, information about battery capacity 7000 of the EV, a present charged amount 7100 in the EV and a power amount 5000 presently consumed in the EV, and moving distances dnm of the EVs covered from the charging station is conceptually shown in FIG. 5.

The data center detects, stores and manages this information, that is, information about the energy amount 4000 generated per unit time from photovoltaic (PV) in the battery storage capacity 6000 of the charging station 210, and information about the present charged amount 6100 and anticipated generation amount information with location information of the charging station.

In addition, the data center analyzes and manages information about the location and moving speed of the moving EV, battery capacity 7000 of the EV, the present charged amount 7100 and the present consumed power amount 5000, and the moving distances dnm of the EVs covered by the charging station.

The data center may charge the EV a flexible fee based on this information, and may calculate a location at which a solar PV charging station is additionally installed by analyzing moving monitoring of the EV. This utilization method may be performed by mapping the EVs covered based on power amounts generated from one PV charging station.

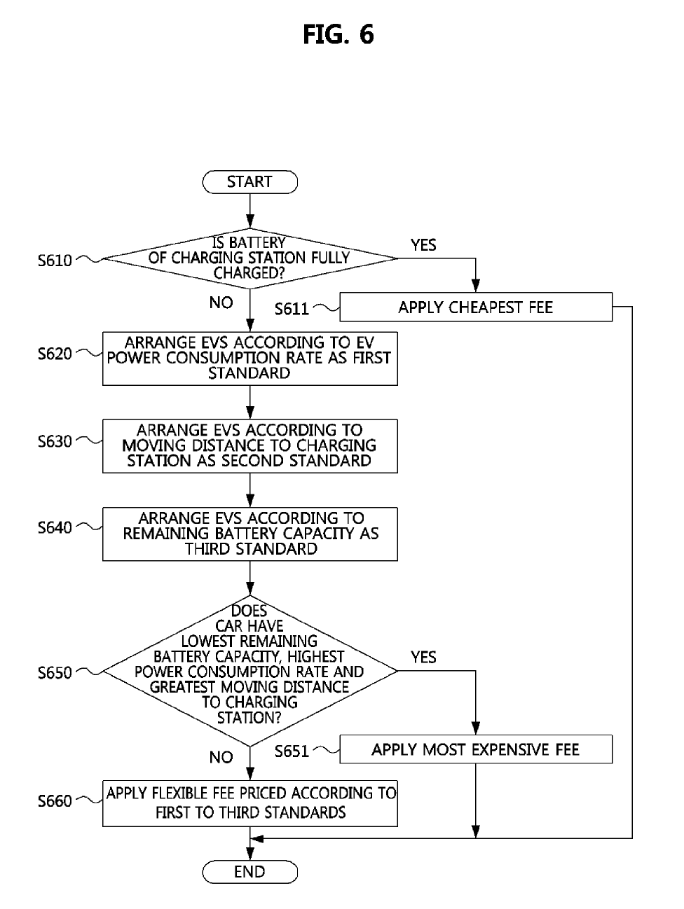

FIG. 6 is a flow chart illustrating a method for applying a flexible fee according to one example embodiment of the present invention.

In description of the example embodiment below, each step of the method for charging the EV of the present invention may be understood as an operation performed in a corresponding element in the data center described with reference to FIG. 7, however the individual steps of the method should only be limited by their own functions by which they are defined. That is, main agents performing the steps are not limited by the names of elements illustrated as performing the steps in the examples.

The following is a description of the method for applying the flexible fee according to one example embodiment of the present invention with reference to FIG. 6.

According to the method for applying the flexible fee according to the present invention, first it is determined that a battery of the charging station is fully charged (S610).

When the battery of the PV charging station is fully charged and a specific EV uses the battery as a mobile battery, the cheapest electrical bill is charged to the EV (S611), and thus power transmitted to the energy grid 100 or leaked from a line may be utilized.

Because the data center manages information about a power consumption rate of each EV, the data center arranges the EVs according to the EV power consumption rate as a first standard (S620). In addition, the data center manages information about distances between the charging station and the EVs, and the data center arranges the EVs according to the moving distance from the EV to charging station as a second standard (S630). In addition, because the data center manages information about remaining battery capacity of the EVs, the data center arranges the EVs according to remaining battery capacity of the EV as a third standard (S640).

The EVs are arranged in priority order according to the first to third standards in the present invention in order to apply a discriminative and flexible fee. Thus, although step S610, step 620 and step 630 are sequentially shown for convenience of description, the steps may actually be simultaneously performed and a sequence of the steps may be changed. In addition, the arrangement standards illustrated in the present invention are merely an example, and it is possible to change them variously including adding an additional standard.

As a result of arranging the EVs according to the first to third standards, an EV determined (S650) as an EV having a lowest remaining battery capacity, a highest power consumption rate and a greatest moving distance to the charging station receives the most expensive fee (S651). Other EVs receive suitable fees according to the flexible fee priced in consideration of the first to third determination standards (S660).

FIG. 7 is a block diagram illustrating the data center according to one example embodiment of the present invention.

Elements described below may be defined by functions performed by the elements, and thus are classified functionally rather than physically. Each of the elements may be implemented with hardware and/or program codes and processing units performing each of functions, and the functions of two or more elements may be included in one element.

Thus, names given to elements in the example embodiment below merely suggest representative functions performed by the elements, but do not serve as physical classifications, and the technical spirit of the present invention is not limited by the names of the elements.

The data center according to the present invention includes an EV energy information collection part 111, a generation related information collection part 112, a control part 113 and an energy and generation information database 114. The data center according to the present invention may be called a new renewable energy management system for an EV.

The EV energy information collection part 111 collects the EV energy related information from at least one EV. The generation information collection part 112 gathers the generation related information from at least one generation complex.

The control part 113 compares the gathered overall generation amount with the anticipated EV consumption amount to process the surplus power amount or generation amount. Specifically, the control part 113 controls the charging station or the EV so that the surplus power amount is transmitted to the energy grid when the overall generation amount is greater than the anticipated EV consumption amount and the generation amount is stored in the charging station or the EV when the overall generation amount is not greater than the anticipated EV consumption amount.

In addition, the control part 113 detects the EV that needs to be charged from EV energy related information collected by the EV energy information collection part 111, selects the charging station for the EV that needs to be charged, and transmits the information about the selected charging station to the EV that needs to be charged.

The data center (or energy management system) according to the present invention may further include a fee charging control part (not shown) that charges according to the flexible fee priced according to at least one charge standard when the generation amount is stored in the EV in the step of processing the surplus power amount or generation amount.

Meanwhile, a function of the fee charging control part may be included in the control part 113 and the fee charging control part and the control part 113 may be combined into one block.

The energy and generation information database 114 stores and manages the EV energy related information and the generation related information collected by the EV energy information collection part 111 and the generation information collection part 112.

The word “database” used in the present invention refers to a functional element storing information, and does not refer strictly to a relational or objected-oriented database, but may be implemented in various types.

For example, the database used in the present invention may be a simple element storing file-based information.

According to the configuration of the present invention as shown through various example embodiments, balance of consumed power of the EV and generated power of the new renewable energy is effectively managed, and thus energy efficiency may be enhanced.

Particularly, although a large storage battery is required according to efficiency of a solar cell in the case of solar generation, the EV uses a mobile battery, and therefore a size of the large storage battery may be miniaturized and there is an effect of cost decrease.

In addition, when the EV needs to be charged and searches for a nearby solar charging station, the EV is guided to a charging station of which generation efficiency is good, and thus electricity generated in the solar generation plant may be directly stored in the EV.

Furthermore, the data center collecting, analyzing and managing information about the PV charging station and the EV is additionally built, and thus energy efficiency is increased by adjusting balance between supply and consumption of energy.

In this specification, exemplary embodiments of the present invention have been classified as first, second and third exemplary embodiments and described for conciseness. However, respective steps or functions of an exemplary embodiment may be combined with those of another exemplary embodiment to implement still another exemplary embodiment of the present invention.

While the invention has been shown and described with reference to certain exemplary embodiments thereof, it will be understood by those skilled in the art that various changes in form and details may be made therein without departing from the spirit and scope of the invention as defined by the appended claims.

1. A method for managing energy, comprising:
collecting electric vehicle (EV) energy related information from at least one EV;
gathering generation related information from at least one new renewable energy plant; and
processing a surplus power amount or generation amount by comparing a gathered overall generation amount with an anticipated EV consumption amount.

2. The method of claim 1, wherein the processing of the surplus power amount or generation amount includes transmitting the surplus power amount to an energy grid when the overall generation amount is greater than the anticipated EV consumption amount.

3. The method of claim 1, wherein the processing of the surplus power amount or generation amount includes storing the generation amount in a charging station or the EV when the overall generation amount is equal to or less than the anticipated EV consumption amount.

4. The method of claim 1, wherein the EV energy related information includes information about at least one of a driving location, a power consumption rate and remaining battery capacity of the EV.

5. The method of claim 1, wherein the generation related information includes information about at least one of an energy generation complex location, a charging station location, generation efficiency and an anticipated generation amount.

6. The method of claim 3, wherein the processing of the surplus power amount or generation amount further includes charging the EV according to a flexible fee priced according to at least one charge standard when the generation amount is stored in the EV.

7. The method of claim 1, wherein the charge standard includes at least one of a power consumption rate of the EV, a moving distance from the EV to a charging station, and remaining battery capacity of the EV.

8. The method of claim 1, further comprising:
detecting the EV that needs to be charged from the collected EV energy related information;
selecting a charging station for the EV that needs to be charged; and
transmitting information about the selected charging station to the EV that needs to be charged.

9. An energy managing system comprising:
an energy information collection part configured to collect electric vehicle (EV) energy related information from at least one EV;
a generation information collection part configured to gather generation related information from at least one new renewable energy plant; and
a control part configured to process a surplus power amount or generation amount by comparing a gathered overall generation amount with an anticipated EV consumption amount.

10. The energy managing system of claim 9, wherein the control part transmits the surplus power amount to an energy grid when the overall generation amount is greater than the anticipated EV consumption amount.

11. The energy managing system of claim 9, wherein the control part control a charging station or the EV to store the generation amount in the charging station or the EV when the overall generation amount is equal to or less than the anticipated EV consumption amount.

12. The energy managing system of claim 9, wherein the EV energy related information includes information about at least one of a driving location, a power consumption rate and remaining battery capacity of the EV.

13. The energy managing system of claim 9, wherein the generation related information includes information about at least one of a charging station location, generation efficiency and an anticipated generation amount.

14. The energy managing system of claim 9, wherein the control part charges the EV according to a flexible fee priced according to at least one charge standard when the generation amount is stored in the EV.

15. The energy managing system of claim 12, wherein the charge standard includes at least one of a power consumption rate of the EV, a moving distance from the EV to a charging station, and remaining battery capacity of the EV.

16. The energy managing system of claim 9, wherein the control part detects the EV that needs to be charged from the EV energy related information collected by the energy information collection part, selects a charging station for the EV that needs to be charged, and transmits information about the selected charging station to the EV that needs to be charged.

17. The energy managing system of claim 9, further comprising:
a database configured to store the EV energy related information and generation related information collected by the energy information collection part and the generation information collection part.

18. An electric vehicle (EV) comprising:
an energy information transmission part configured to periodically transmit EV energy related information to a data center; and
a charge control part configured to determine whether charging is needed based on remaining battery capacity information, transmit a charging guide request to the data center when the charging is needed, and receive a charging station guide message from the data center.

19. The EV of claim 18, wherein the EV energy related information includes information about at least one of a driving location, a power consumption rate and remaining battery capacity of the EV.
